(19) United States
(12) Patent Application Publication
(10) Pub. No.: US 2023/0197085 A1
(43) Pub. Date: Jun. 22, 2023

(54) VOICE OR SPEECH RECOGNITION IN NOISY ENVIRONMENTS

(71) Applicant: QUALCOMM Incorporated, San Diego, CA (US)

(72) Inventors: Xiaoxia DONG, SHENZHEN (CN); Jun WEI, SHENZHEN (CN); Qimeng PAN, SHENZHEN (CN)

(21) Appl. No.: 17/997,243

(22) PCT Filed: Jun. 22, 2020
(86) PCT No.: PCT/CN2020/097357

§ 371 Date: Oct. 26, 2022

(51) Int. Cl. G10L 17/20; G10L 25/51; G10L 21/0216; G10L 17/22

(52) U.S. Cl. CPC G10L 17/20; G10L 25/51; G10L 21/0216; G10L 17/22

(57) ABSTRACT

Embodiments include methods for voice/speech recognition in noisy environments executed by a processor of a computing device. In various embodiments, voice or speech recognition may be executed by a processor of a computing device, which may include determining a voice recognition model to use for voice and/or speech recognition based on a location where an audio input is received and performing voice and/or speech recognition on the audio input using the determined voice recognition model. Some embodiments my receive from a computing device, an audio input and location information associated with a location where the audio input was recorded. The received audio input may be used to generate a voice recognition model associated with the location where the audio input was recorded for use in voice and/or speech recognition. The generated voice recognition model associated with the location may be provided to the computing device.

### BACKGROUND

Modern computing devices, like cell phones, laptops, tablets, and desktops, use speech and/or voice recognition for various functions. Speech recognition extracts the words that are spoken whereas voice recognition (referred to as speaker identification) identifies the voice that is speaking, rather than the words that are spoken. Thus, speech recognition determines “what someone said,” while voice recognition determines “who said it” Speech recognition is handy for providing verbal commands to computing devices, thus eliminating the need to touch or directly engage a keyboard or touch-screen. Voice recognition provides a similar convenience, but may also be applied as an identification authentication tool. Also, identifying the speaker may improve speech recognition by using a more appropriate voice recognition model that is customized for that speaker. While contemporary software/hardware has improved deciphering the subtle nuances of speech and voice recognition, the accuracy of such systems is generally impacted by ambient noise. Even systems that attempt to filter-out ambient noise have trouble accounting for the variations in ambient noise that occurs in different locations or types of location.

### SUMMARY

Various aspects include methods and computing devices implementing the methods for voice and/or speech recognition in noisy environments executed by a processor of a computing device. Various aspects may include voice or speech recognition executed by a processor of a computing device, which may include determining a voice recognition model to use for voice and/or speech recognition based on a location where an audio input is received and performing voice and/or speech recognition on the audio input using the determined voice recognition model.

Further aspects may include using global positioning system information, ambient noise, and/or communication network information to determine the location where the audio input is received. In some aspects, determining a voice recognition model to use for voice and/or speech recognition may include selecting the voice recognition model from a plurality of voice recognition models, wherein each of the plurality of voice recognition models is associated with a different scene category, each having a designated audio profile. In some aspects, performing voice and/or speech recognition on the audio input using the determined voice recognition model may include using the determined voice recognition model to adjust the audio input for ambient noise and performing voice and/or speech recognition on the adjusted audio input.

Further aspects may include receiving an audio input associated with ambient noise sampling at the location, associating the location or a location category with the received audio input, and transmitting the audio input and associated location or location category information to a remote computing device for generating the voice recognition model for the associated location or location category based on the received audio input.

Further aspects ma include compiling an audio profile from an audio input associated with ambient noise at the location, associating the location or a location category with the compiled audio profile, and transmitting the audio profile associated with the location or location category to a remote computing device for generating the voice recognition model for the location or location category based on the compiled audio profile.

Various aspects may use a computing device to generate a speech recognition model. The generation of the speech recognition model may include receiving, from user equipment remote from the computing device, an audio input and location information associated with a location where the audio input was recorded, using the received audio input to generate a voice recognition model associated with the location for use in voice and/or speech recognition, and providing the generated voice recognition model associated with the location to the user equipment.

In further aspects, receiving the audio input and location information further may include receiving a plurality of audio inputs, each having location information associated with different locations. Also, using the received audio input to generate a voice recognition model associated with the location may further include using the received plurality of audio inputs to generate voice recognition models, in which each of the generated voice recognition models may be configured to be used at a respective one of the different locations.

Further aspects may further include determining a location category based on the location information received from the user equipment, and associating the generated voice recognition model with the determined location category.

Further aspects include a computing device including a processor configured with processor-executable instructions to perform operations of any of the methods summarized above. Further aspects include a non-transitory processor-readable storage medium having stored thereon processor-executable software instructions configured to cause a processor to perform operations of any of the methods summarized above. Further aspects include a processing device for use in a computing device and configured to perform operations of any of the methods summarized above.

### BRIEF DESCRIPTION OF THE DRAWINGS

The accompanying drawings, which are incorporated herein and constitute part of this specification, illustrate exemplary embodiments, and together with the general description given above and the detailed description given below, serve to explain the features of the various embodiments.

FIGS. 1A and 1B are schematic diagrams illustrating example systems configured for voice and/or speech recognition executed by a processor of one or more computing devices.

FIG. 2 is a schematic diagram illustrating components of an example system in a package for use in a computing device in accordance with various embodiments.

FIG. 3 shows a component block diagram of an example system configured for voice and/or speech recognition executed by a processor of a computing device.

FIGS. 4A, 4B. 4C, 4D, 4E, and/or 4F show process flow diagrams of example methods for voice and/or speech recognition executed by a processor of a computing device according to various embodiments.

FIGS. 5A and/or 5B show process flow diagrams of example methods for voice and/or speech recognition executed by a processor of a computing device according to various embodiments.

FIG. 6 is a component block diagram of a network server computing device suitable for use with various embodiments.

FIG. 7 is a component block diagram of a mobile computing device suitable for use with various embodiments.

### DETAILED DESCRIPTION

Various aspects will be described in detail with reference to the accompanying drawings. Wherever possible, the same reference numbers will be used throughout the drawings to refer to the same or like parts. References made to particular examples and embodiments are for illustrative purposes and are not intended to limit the scope of the various aspects or the claims.

Various embodiments provide methods for voice and/or speech recognition in varied environments and/or noisy environments executed by a processor of a computing device. Various embodiments may determine a voice recognition model to use for voice and/or speech recognition based on a location where an audio input is received. Voice and/or speech recognition may be performed on the audio input using the determined voice recognition model.

As used herein, the term “voice recognition model” is used herein to refer to a quantified set of values and/or a mathematical description configured to be used, under a specified set of circumstances, for computer-based predictive analysis of an audio signal for automatic voice and/or speech recognition, which includes translation of spoken language into text and/or the identification of the speaker. In voice recognition, the sounds of the speaker's voice and particular keywords or phrases may be used to recognize and authenticate the speaker, much like a finger print sensor or a facial recognition process. In speech recognition, the sounds of the speaker's voice are transcribed into words (i.e., text) and/or commands that can be processed and stored by the computing device. For example, a user may speak a key phrased to enable voice recognition and authentication of the user, after which the user may dictate to the computing device, which transcribes the user's words using speech recognition methods. Various embodiments improve both voice recognition and speech recognition by using trained voice recognition models that account for ambient sounds where the speaker is using the computing device. For example, a first voice recognition model may be used for voice and/or speech recognition of utterances by a speaker in a first environment (e.g., in a quiet office), while a second voice recognition model may be used for voice and/or speech recognition of utterance from that same speaker in a second environment that is typically noisier than the first environment or generally has a different level or type of ambient background noise (e.g., at home with family). Each voice recognition model may take into account special characteristics of the speaker's voice, the typical ambient noise in a particular background, location or environment, and/or characteristics of background noise in a class or type of location (e.g., restaurant, automobile, city street, etc.). Voice and/or speech recognition may be accomplished more accurately in the presence of background noise in the second environment using a voice recognition model that accounts for the background noise, and thus is different from the voice recognition model used in the first environment where there is no or different background noise.

As used herein, the term “computing device” refers to an electronic device equipped with at least a processor, communication systems, and memory configured with a contact database. For example, computing devices may include any one or all of cellular telephones, smartphones, portable computing devices, personal or mobile multi-media players, laptop computers, tablet computers, 2-in-1 laptop/table computers, smartbooks, ultrabooks, palmtop computers, wireless electronic mail receivers, multimedia Internet-enabled cellular telephones, wearable devices including smart watches, entertainment devices (e.g., wireless gaming controllers, music and video players, satellite radios, etc.), and similar electronic devices that include a memory, wireless communication components and a programmable processor. In various embodiments, computing devices may be configured with memory and/or storage. Additionally, computing devices referred to in various example embodiments may be coupled to or include wired or wireless communication capabilities implementing various embodiments, such as network transceiver(s) and antenna(s) configured to communicate with wireless communication networks.

The term “system on chip” (SOC) is used herein to refer to a single integrated circuit (IC) chip that contains multiple resources and/or processors integrated on a single substrate. A single SOC may contain circuitry for digital, analog, mixed-signal, and radio-frequency functions. A single SOC may also include any number of general purpose and/or specialized processors (digital signal processors, modem processors, video processors, etc.), memory blocks (e.g., ROM, RAM, Flash, etc.), and resources (e.g., timers, voltage regulators, oscillators, etc.). SOCs may also include software for controlling the integrated resources and processors, as well as for controlling peripheral devices.

The term “system in a package” (SIP) may be used herein to refer to a single module or package that contains multiple resources, computational units, cores and/or processors on two or more IC chips, substrates, or SOCs. For example, a SIP may include a single substrate on which multiple IC chips or semiconductor dies are stacked. In a vertical configuration. Similarly, the SIP may include one or more multi-chip modules (MCMs) on which multiple ICs or semiconductor dies are packaged into a unifying substrate. A SIP may also include multiple independent SOCs coupled together via high speed communication circuitry and packaged in close proximity, such as on a single motherboard or in a single wireless device. The proximity of the SOCs facilitates high speed communications and the sharing of memory and resources.

As used herein, the terms “component,” “system,” “unit,” “module,” and the like include a computer-related entity, such as, but not limited to, hardware, firmware, a combination of hardware and software, software, or software in execution, which are configured to perform particular operations or functions. For example, a component may be, but is not limited to, a process running on a processor, a processor, an object, an executable, a thread of execution, a program, and/or a computer. By way of illustration, both an application running on a communication device and the communication device may be referred to as a component. One or more components may reside within a process and/or thread of execution and a component may be localized on one processor or core and/or distributed between two or more processors or cores. In addition, these components may execute from various non-transitory computer readable media having various instructions and/or data structures stored thereon. Components may communicate by way of local and/or remote processes, function or procedure calls, electronic signals, data packets, memory read/writes, and other known computer, processor, and/or process related communication methodologies.

Voice and speech recognition systems according to various embodiments may employ deep learning techniques and draw from big data (i.e., large collective data sets) to generate voice recognition models that will accurately translate speech to text, provide speech activation functions, and/or determine or confirm the identity of the speaker (i.e., authentication) in the presence of different types of background noise. By using customized voice recognition models tailored for specific locations or types of locations, systems employing various embodiments may provide improved voice and/or speech recognition performance by reducing the impact on accuracy or recognition that environmental noise can have on voice and/or speech recognition systems.

In various embodiments, a processor of a computing device may generate voice recognition models that may be used for different environments that correspond to different locations or types of locations. The voice recognition models may be generated from audio samples or profiles provided from user equipment, crowd sourced data, and/or other sources. For example, a user may provide samples of ambient noise from personal environments, like home, office, or places the user commonly visits. Such samples of ambient noise may be used to generate voice recognition models for each respective location or categories of locations. Alternatively or additionally, the processor may generate voice recognition models from crowd sourcing or generalized recordings of environments that correspond to different common locations or types of locations in which typical user utterances are collected. For example, ambient noise on trains, buses, parks, restaurants, hospital, etc. may be used to generate voice recognition models for each respective location or categories of locations.

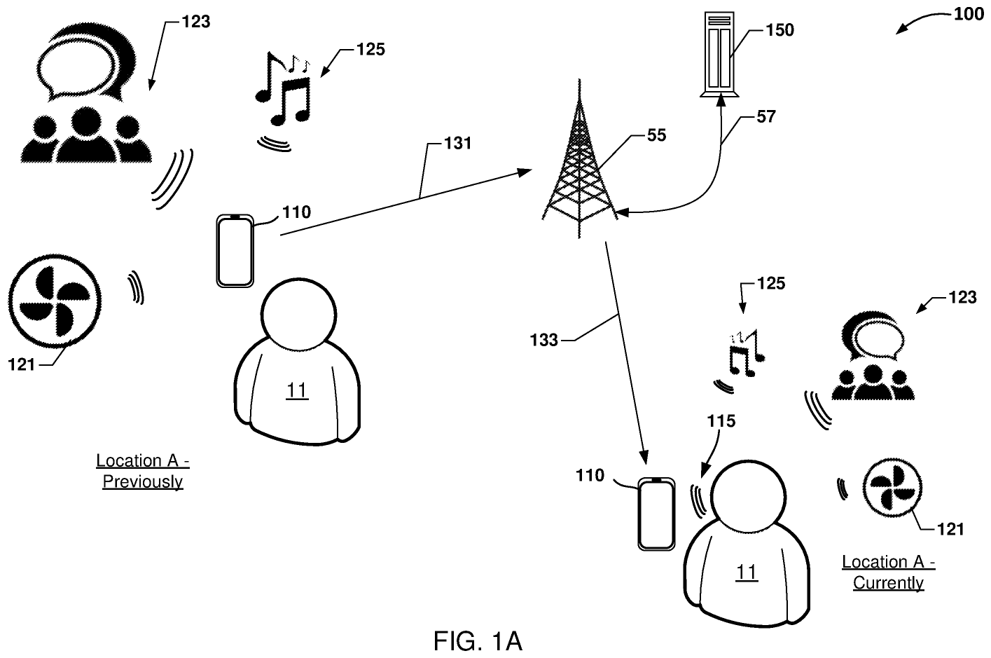

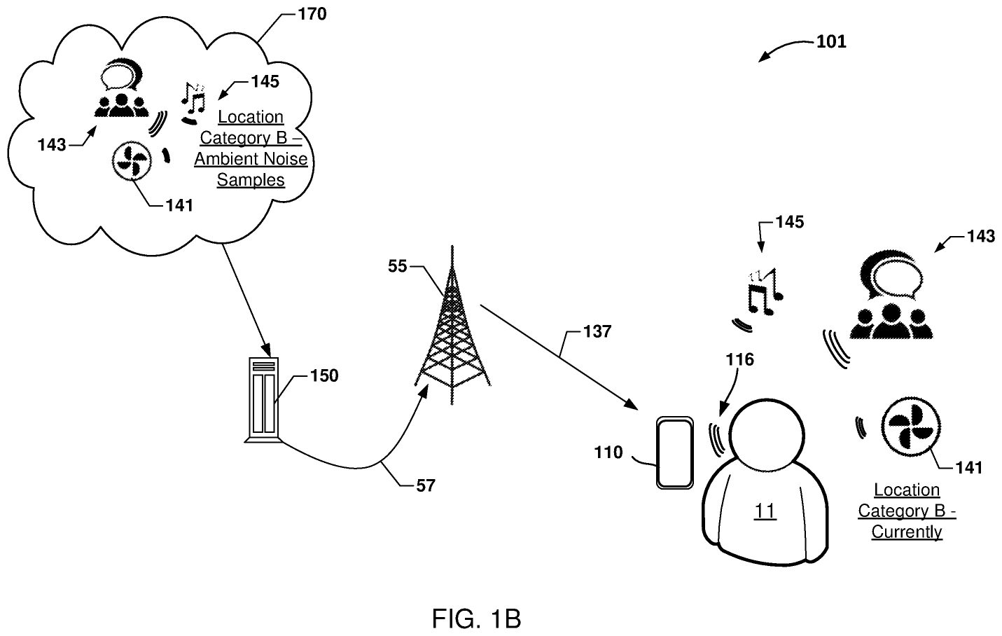

FIGS. 1A-1B illustrate computing devices 110, 150 configured to provide voice and/or speech recognition functions in accordance with various embodiments. In particular, FIGS. 1A-1B illustrate environments 100, 101 in which a user, operating user equipment 110 at Location A, speaks an utterance 115 for the user equipment 110 to perform voice and/or speech recognition on the utterance 115. The environments 100, 101 may include the user equipment 110, operated by a user 11, and/or one or more remote computing device(s) 150. The user equipment 110 may represent almost any mobile computing device, into which a user (e.g., the user 11) may speak as a means of user input using voice and/or speech recognition. The user equipment 110 may be configured to perform wireless communications, such as to communicate with the remote computing device(s) 150. In this way, the user equipment 110 may communicate via one or more base stations 55, which in-turn may be communicatively coupled to the remote computing device(s) 150 through wired and/or wireless connections 57.

The environments 100, 101 may also include the remote computing device(s) 150, which may be part of a cloud-based computing network configured to help the user equipment 110 improve voice and/or speech recognition by providing different voice recognition models that may be selected and used by the user equipment 110, depending on a current location thereof. The remote computing device(s) 150 may compile a plurality of voice recognition models for use by the user equipment 110. Each voice recognition model may be used in a different environment (i.e., a location or location category) to convert utterances by the user 11 to text and/or operate other functions of the user equipment 110.

FIG. 1A shows the environment 100 in which the user 11 collected (i.e., at a previous point in time) one or more samples of ambient noise through the user equipment 110 at a location, labeled Location A. The user equipment 110 recorded an audio input representing the ambient sounds at Location A from one or more sources 121, 123, 125. Alternatively, the recorded audio input may represent ambient sounds at a category of location, of which Location A is one. The one or more sources 121, 123, 125 may include any elements generating noise at Location A, such as machine sounds 121, background conversations 123, music 125, and/or virtually anything making noise at Location A at the time the audio input is recorded by the user equipment 110. The user equipment 110 thereafter transmits the ambient noise sample(s), along with location information to the remote computing device 150 for generating a customized voice recognition model associated with Location A. Location A may represent a location at which the user 11 often uses the user equipment 110 for voice and/or speech recognition, such as the user's home, office, or similar frequented location.

In various embodiments, the user equipment 110 may transmit the received audio input and associated location information (i.e., identifying Location A) to the remote computing device 150 for generating a voice recognition model associated with Location A or a location category that includes Location A based on the received audio input. Alternatively, the user equipment 110 may transmit an audio profile, which may additionally include characteristics or other information associated with the received audio input. The user equipment 110 may transmit the audio input with the location or location category information and/or the audio profile using exchange signals 131 to a local base station 55 that is communicatively coupled to the remote computing device(s) 150.

In various embodiments, the remote computing device(s) 150 may use the received audio input (i.e., an ambient noise sample) with the location information and/or the audio profile to generate a voice recognition model associated with Location A for future voice and/or speech recognition performed on utterances at Location A. This voice recognition model, which is associated with Location A, may alter the way sounds of the user's speech are recognized during voice and/or speech recognition at Location A. The remote computing device(s) 150 may have transmitted the generated voice recognition model associated with Location A back to the user equipment 110, via exchange signals 133. Also, the user equipment 110 may have stored the generated voice recognition model for use in performing future voice and/or speech recognition on utterances detected at Location A.

Having previously stored the generated voice recognition model, FIG. 1A further shows the user 11 currently at Location A with the user equipment 110. While at Location A, the user 11 is speaking (i.e., emitting an utterance 115), which may be received by a microphone of the user equipment 110 as an audio input, along with background ambient noise from the one or more sources 121, 123, 125. In response to receiving the audio input at Location A, the user equipment 110 may determine a voice recognition model to use for voice and/or speech recognition based on the location where the audio input is received. Thus, the user equipment 110 may select the voice recognition model associated with Location A. In addition, the user equipment 110 may perform voice and/or speech recognition on the audio input using the determined voice recognition model for Location A.

FIG. 1B shows the environment 101 in which the remote computing device 150 collected (i.e., at a previous point in time) one or more ambient noise samples 170, associated with a category of location (i.e., Location Category B), by crowdsourcing. In this way, the remote computing device 150 obtained ambient noise sample(s) and/or information about ambient noise samples by enlisting the services of a large number of people, either paid or unpaid, typically via the Internet. The location categories may represent many different locations whose audio profiles have similar or the same characteristics. For example, the location categories may include restaurants, airports, train stations, bus stations, malls, grocery stores, etc. Alternatively, the crowd sourced ambient noise samples may represent ambient sounds at a specific location, like Location A, rather than a category of locations (e.g., Location Category B). Additionally, or as a further alternative, the Location Category B—ambient noise samples 170 may have been recorded and/or compiled by a third-party source.

The Location Category B—ambient noise samples 170 may represent the ambient sounds at one or more locations that fall under Location Category B from one or more sources 141, 143, 145. The one or more sources 141, 143, 145 may include any elements generating noise at locations that fall under Location Category B, such as machine sounds 121, background conversations 123, music 125, and/or virtually anything making noise at those locations. The Location Category B may represent a category of locations at which the user 11 uses the user equipment 110 for voice and/or speech recognition.

in various embodiments, the remote computing device(s) 150 may use the received Location Category B—ambient noise samples 170 with the location category information to generate a voice recognition model associated with Location Category B for future voice and/or speech recognition performed on utterances at a location that falls within Location Category B. This voice recognition model, which is associated with Location Category B, may alter the way utterances from the user 11 are recognized during voice and/or speech recognition at the Location Category B. The remote computing device(s) 150 may have transmitted the generated voice recognition model associated with Location Category B to the user equipment 110. via exchange signals 137. Also, the user equipment 110 may have stored the generated voice recognition model for use in performing future voice and/or speech recognition on utterances detected at a location that falls within Location Category B.

FIG. 1B further shows the user 11 currently at a location that corresponds to Location Category B with the user equipment 110. While at the Location Category B, the user 11 is speaking (i.e., emitting an utterance 116), which may be received by a microphone of the user equipment 110 as an audio input along with background ambient noise from the one or more sources 141, 143, 145. In response to this current receipt of the audio input at the Location Category B, the user equipment 110 may determine a voice recognition model to use for voice and/or speech recognition based on the location category where the audio input is received. Thus, the user equipment 110 may select the voice recognition model associated with Location Category B. In addition, the user equipment 110 may perform voice and/or speech recognition on the audio input using the determined voice recognition model for Location Category B.

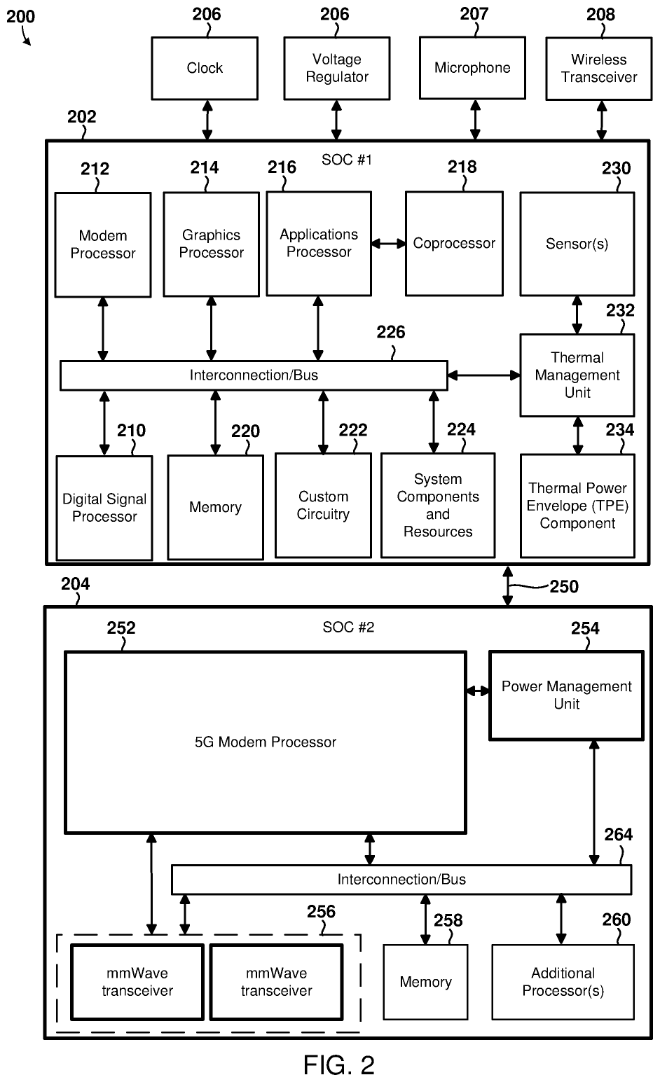

With reference to FIGS. 1A-2, the illustrated example SIP 200 includes a two SOCs 202, 204, a clock 205, a voltage regulator 206, a microphone 207, and a wireless transceiver 208. In some embodiments, the first SOC 202 operates as central processing unit (CPU) of the wireless device that carries out the instructions of software application programs by performing the arithmetic, logical, control and. input/output (I/O) operations specified by the instructions. In some embodiments, the second SOC 204 may operate as a specialized processing unit. For example, the second SOC 204 may operate as a specialized 5G processing unit responsible for managing high volume, high speed (e.g., 5 Gbps, etc.), and/or very high frequency short wave length (e.g., 28 GHz mmWave spectrum, etc.) communications.

The first SOC 202 may include a digital signal processor (DSP) 210, a modem processor 212, a graphics processor 214, an application processor 216, one or more coprocessors 218 (e.g., vector co-processor) connected to one or more of the processors, memory custom circuitry 222, system components and resources 224, an interconnection/bus module 226, one or more temperature sensors 230, a thermal management unit 232, and a thermal power envelope (TPE) component 234. The second SOC 204 may include a 5G modem processor 252, a power management unit 254, an interconnection/bus module 264, a plurality of mmWave transceivers 256, memory 258, and various additional processors 260, such as an applications processor, packet processor, etc.

Each processor 210, 212, 214, 216, 218, 252, 260 may include one or more cores, and each processor/core may perform operations independent of the other processors/cores. For example, the first SOC 202 may include a processor that executes a first type of operating system (e.g., FreeBSD, LINUX, OS X, etc.) and a processor that executes a second type of operating system (e.g., MICROSOFT WINDOWS 10). In addition, any or all of the processors 210, 212, 214, 216, 218, 252, 260 may be included as part of a processor cluster architecture (e.g., a synchronous processor cluster architecture, an asynchronous or heterogeneous processor cluster architecture, etc.).

The first and second SOC 202, 204 may include various system components, resources and custom circuitry for managing sensor data, analog-to-digital conversions, wireless data transmissions, and for performing other specialized operations, such as decoding data packets and processing encoded audio and video signals for rendering in a web browser. For example, the system components and resources 224 of the first SOC 202 may include power amplifiers, voltage regulators, oscillators, phase-locked loops, peripheral bridges, data controllers, memory controllers, system controllers, access ports, timers, and other similar components used to support the processors and software clients running on a wireless device. The system components and resources 224 and/or custom circuitry 222 may also include circuitry to interface with peripheral devices, such as cameras, electronic displays, wireless communication devices, external memory chips, etc.

The first and second SOC 202, 204 may communicate via interconnection/bus module 250. The various processors 210, 212, 214 216, 218, may be interconnected to one or more memory elements 220, system components and resources 224, and custom circuitry 222, and a thermal management unit 232 via an interconnection/bus module 226. Similarly, the processor 252 may be interconnected to the power management unit 254, the mmWave transceivers 256, memory 258, and various additional processors 260 via the interconnection/bus module 264. The interconnection/bus module 226, 250, 264 may include an array of reconfigurable logic gates and/or implement a bus architecture (e.g., CoreConnect, AMBA, etc.). Communications may be provided by advanced interconnects, such as high-performance networks-on chip (NoCs).

The first and/or second SOCs 202, 204 may further include an input/output module (not illustrated) for communicating with resources external to the SOC, such as a clock 205 and a voltage regulator 206. Resources external to the SOC (e.g., clock 205, voltage regulator 206) may be shared by two or more of the internal SOC processors/cores.

in addition to the example SIP 200 discussed above, various embodiments may be implemented in a wide variety of computing systems, which may include a single processor, multiple processors, multicore processors, or any combination thereof.

Various embodiments may be implemented using a number of single processor and multiprocessor computer systems, including a system-on-chip (SOC) or system in a package (SIP). FIG. 2 illustrates an example computing system or SIP 200 architecture that may be used in user equipment (e.g., 110), remote computing devices (e.g., 150), or other systems for implementing the various embodiments.

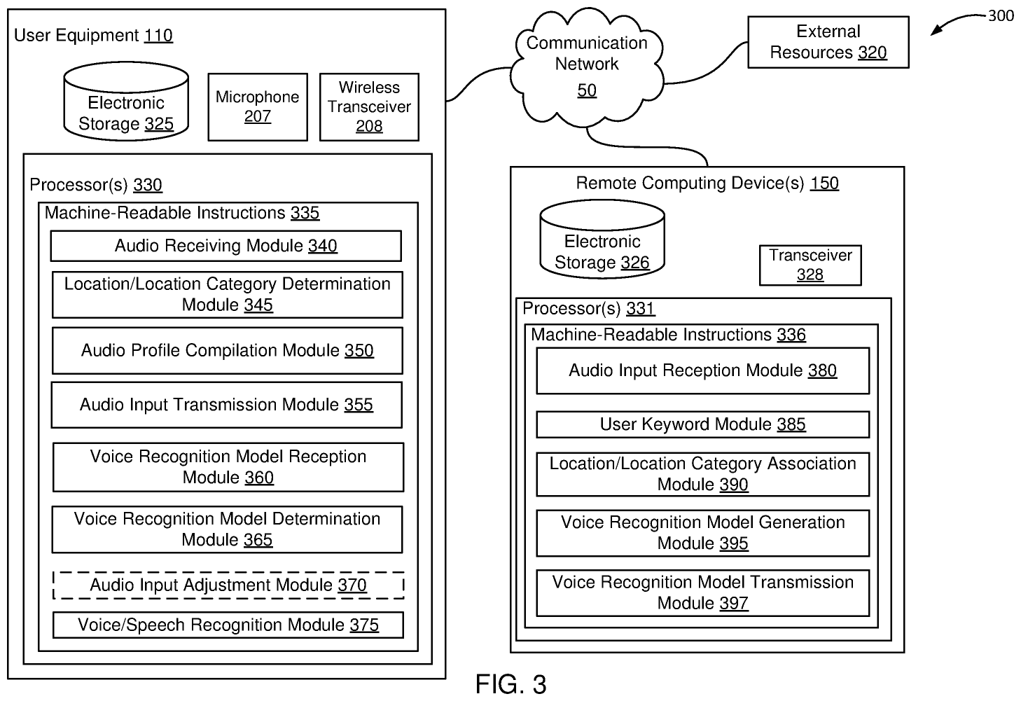

FIG. 3 is a component block diagram illustrating a system 300 configured for voice and/or speech recognition executed by a processor of one or more computing devices in accordance with various embodiments. In sonme embodiments, the system 300 may include the user equipment 110 and/or the one or more remote computing device(s) 150. The user equipment 110 may represent almost any mobile computing device, into which a user may speak as a means of user input using voice and/or speech recognition. The system 300 may also include remote computing device(s) 150, which may be part of a cloud-computing network configured to help the user equipment 110 improve voice and/or speech recognition by providing different voice recognition models that may be selected and used by the user equipment 110 depending on a current location thereof Each voice recognition model may be used in different environments (i.e., locations or location categories) to convert utterances by the user (i.e., speech) to text, identify/authenticate the user, and/or to operate other functions of the user equipment 110 in response to verbal commands. The remote computing device(s) 150 may compile a plurality of voice recognition models for use by the user equipment 110.

The user equipment may include a microphone 207 for receiving sound (i.e., an audio input), which may be digitized into data packets for analysis and/or transmission. The audio input may include ambient sounds in the vicinity of the user equipment 110 and/or speech from a user of the user equipment 110. Also, the user equipment 110 may be communicatively coupled to peripheral device(s) (not shown), and configured to communicate with the remote computing device(s) 150 and/or external resources 320 using a wireless transceiver 208 and a communication network 50, such as a cellular communication network. Similarly, the remote computing device(s) 150 may be configured to communicate with the user equipment 110 and/or the external resources 320 using a wireless transceiver 208 and the communication network 50.

The user equipment 110 may also include electronic storage 325, one or more processors 330, and/or other components. The user equipment 110 may include communication lines, or ports to enable the exchange of information with a network and/or other computing platforms, such as the remote computing device(s) 150. Illustration of the user equipment 110 in FIG. 1 is not intended to be limiting. The user equipment 110 may include a plurality of hardware, software, and/or firmware components operating together to provide the functionality attributed herein to the user equipment 110.

The remote computing device(s) 150 may include electronic storage 326, one or more processors 331, and/or other components. The remote computing device(s) 150 may include communication lines, or ports to enable the exchange of information with a network, other computing platforms, and many user mobile computing devices, such as the user equipment 110. Illustration of the remote computing device(s) 150 in FIG. 3 is not intended to be limiting. The remote computing device(s) 150 may include a plurality of hardware, software, and/or firmware components operating together to provide the functionality attributed herein to the remote computing device(s) 150.

External resources 320 include remote servers that may receive sound recordings and generate voice recognition models for various locations and categories of locations, as well as provide voice recognition models to computing devices, such as in downloads via the communication network 50. External resources 320 may receive sound recordings and information from voice and/or speech recognition processing performed. In various locations from a plurality of user equipments and computing devices through crowd sourcing processes.

Electronic storage 325, 326 may comprise non-transitory storage media that electronically stores information. The electronic storage media of electronic storage 325, 326 may include one or both of system storage that is provided integrally (i.e., substantially non-removable) with the user equipment 110 or remote computing device(s) 150, respectively, and/or removable storage that is removably connectable thereto. For example, a port (e.g., a Universal Serial Bus (USB) port, a Fire Wire port, etc.) or a drive (e.g., a disk drive, etc.). Electronic storage 325, 326 may include one or more of optically readable storage media (e.g., optical disks, etc.), magnetically readable storage media (e.g., magnetic tape, magnetic hard drive, floppy drive, etc.), electrical charge-based storage media (e.g., EEPROM, RAM, etc.), solid-state storage media (e.g., flash drive, etc.), and/or other electronically readable storage media. Electronic storage 325, 326 may include one or more virtual storage resources (e.g., cloud storage, a virtual private network, and/or other virtual storage resources). Electronic storage 325., 326 may store software algorithms, information determined by processor(s) 330, 331, information received from the user equipment 110 or remote computing device(s) 150, respectively, that enables the user equipment 110 or remote computing device(s) 150, respectively to function as described herein.

Processor(s) 330, 331 may be configured to provide information processing capabilities in the user equipment 110 or remote computing device(s) 150, respectively. As such, processor(s) 330, 331 may include one or more of a digital processor, an analog processor, a digital circuit designed to process information, an analog circuit designed to process information, a state machine, and/or other mechanisms for electronically processing information. Although processor(s) 330, 331 are each shown in FIG. 3 as a single entity, this is for illustrative purposes only. In some implementations, processor(s) 330, 331 may include a plurality of processing units. These processing units may be physically located within the same device, or processor(s) 330, 331 may represent processing functionality of a plurality of devices, remote and/or local to one another, operating in coordination.

The user equipment 110 may be configured by machine-readable instructions 335, which may include one or more instruction modules. The instruction modules may include computer program modules. In particular, the instruction modules may include one or more of an audio receiving module 340, a location/location category determination module 345, an audio profile compilation module 350, an audio input transmission module 355, a voice recognition model reception module 360, a voice recognition model determination module 365, an audio input adjustment module 370, a voice and/or speech recognition module 375 (i.e., Voice/Speech Recognition Module 375), and/or other instruction modules.

The audio receiving module 340 may be configured to receive an audio input associated with ambient noise sampling and/or user speech at a current location of the user equipment 110. The audio receiving module 340 may receive sounds (i.e., audio inputs) from the microphone 207, and digitize them into data packets for analysis and/or transmission. For example, the audio receiving module 340 may receive ambient noise from one or more locations, as well as a user's speech. The audio inputs received by the audio receiving module 340 may be used for an audio sampling mode and/or a voice/speech recognition mode. In the audio sampling mode, received ambient noise may be used to train (i.e., generate) voice recognition models. in the audio sampling mode, the user's speech that is received may include keywords and/or phrases spoken by a user, which may be used to train voice recognition models. in contrast, in the voice/speech recognition mode, received user utterances (i.e., speech) may be used for voice and/or speech recognition. By way of non-limiting example, means for implementing the machine-readable instruction 335 of the audio receiving module 340 may include a processor (e.g., 210, 212, 214, 216, 218, 252, 260, 330, 331) of a processing device (e.g., 110, 150) may use the electronic storage 325, 326, external resources 320, one or more sensor(s) (e.g., microphone 207), and an audio profile database for storing received audio input.

The location/location category determination module 345 may be configured to determine a location and/or a location category of the user equipment 110. The location/location category determination module 345 may determine the location and/or the location category of the user equipment 110 in one or more ways. By accessing a global positioning system, the location/location category determination module 345 may use global positioning system information to determine the location where the audio input is received. The location/location category determination module 345 may additionally or alternatively use ambient noise to determine the location where the audio input is received. For example, the location/location category determination module 345 may compare a current sample of ambient noise, collected by the audio receiving module 340, with one or more audio profiles compiled and maintained by the audio profile compilation module 350. In response to finding an audio profile that matches the current sample of ambient noise, the location/location category determination module 345 may determine the location and/or location category, which will be associated with the audio profile. Also, the location/location category determination module 345 may further or alternatively use communication network information to determine the location where the audio input is received. For example, some network connections, such as those using Bluetooth, and other protocols, may be associated with a fixed location (e.g., home, office, etc.). Thus, once the user equipment 110 connects that that network connection, the location/location category determination module 345 may infer a location and/or location category of the user equipment and the received ambient noise. By way of non-limiting example, means for implementing the machine-readable instruction 335 of the machine-readable instruction 335 of the location/location category determination module 345 may include a processor (e.g., 210, 212, 214, 216, 218, 252, 260, 330, 331) of a processing device (e.g., 110 150) may use the electronic storage 325, 326, external resources 320, one or more sensor(s) (e.g., motion sensors, GPS, microphone, etc.), data input systems (e.g., touch-sensitive input/display and/or connected accessories), and communication systems (e.g., wireless transceiver) for determining a location or location category in which the user device is located.

The audio profile compilation module 350 may be configured to compile an audio profile, from the audio input received by the audio receiving module 340 in the audio sampling mode. The audio profile may include the audio input received by the audio receiving module 340 and/or a sample thereof (e.g., ambient noise and/or user keyword utterance(s)). In addition, the audio profile may include an indication as to the location or the location category determined by the location/location category determination module 345. Further, the audio profile compilation module 350 may be configured to analyze, tag, and/or convert the received audio input or sample to an appropriate format for transmission to the remote computing device 150. By way of non-limiting example, means for implementing the machine-readable instruction 335 of the audio profile compilation module 350 may include a processor (e.g., 210, 212, 214, 216, 218, 252, 260, 330, 331) of a processing device (e.g., 110, 150), the electronic storage 325, 326, external resources 320, one or more sensor(s) (e.g., microphone 207), and an audio profile database for compiling audio inputs.

The audio input transmission module 355 may be configured to transmit the audio input received by the audio receiving module 340, a sample thereof, and/or an audio profile compiled by and received from the audio profile compilation module 350 to the remote computing device 150. Thus, the audio input transmission module 355 may transmit the received audio input and an associated location or location category to the remote computing device(s) 150 for generating a voice recognition model for the associated location or location category based on the received audio input. Similarly, the audio input transmission module 355 may transmit the audio profile associated with the location or location category to the remote computing devices) 150 for generating the voice recognition model for the location or location category based on the compiled audio profile. By way of non-limiting example, means for implementing the machine-readable instruction 335 of the audio input transmission module 355 may include a processor (e.g., 210, 212, 214, 216, 218, 252, 260, 330, 331) of a processing device (e.g., 110, 150), the electronic storage 325, 326, external resources 320, and the wireless transceiver 208 for transmitting ambient noise samples or profiles.

The voice recognition model reception module 360 may be configured to receive, from the remote computing device(s) 150, a generated speech recognition model that is associated with a particular location and/or location category. As described further below, the remote computing device(s) 150 may generate user-customized voice recognition models based on the ambient noise or user keyword utterances received from the user equipment 110. The user-customized voice recognition models may be generated specifically for the user's particular user equipment 110. In addition, the remote computing device(s) 150 may generate generic voice recognition models based on crowd-sourced samples and/or information about particular locations or categories of locations. Each voice recognition model may be associated with a different location or category of location. By way of non-limiting example, means for implementing the machine-readable instruction 335 of the voice recognition model reception module 360 may include a processor (e.g., 210, 212, 214, 216, 218, 252, 260, 330, 331) of a processing device (e.g., 110, 150), the electronic storage 325, 326, external resources 320, and the wireless transceiver 208 for receiving the voice recognition models.

The voice recognition model determination module 365 may be used in the voice and/or speech recognition mode. The voice recognition model may be configured to determine (e.g., select from a library of models) a voice recognition model to use for voice and/or speech recognition based on a location where an audio input is received. In some embodiments, the voice recognition model may be selected from a plurality of voice recognition models, wherein each of the plurality of voice recognition models is associated with a different scene category each having a designated audio profile. By way of non-limiting example, means for implementing the machine-readable instruction 335 of the voice recognition model determination module 365 may include a processor (e.g., 210, 212, 214, 216, 218, 252, 260, 330, 331) of a processing device (e.g., 110, 150) may use the electronic storage 325, 326, external resources 320, and a voice recognition model database for accessing information about various voice recognition models.

The optional audio input adjustment module 370 may be configured to adjust the audio input for ambient noise using the selected voice recognition model. For example, the voice recognition model may be used to filter out ambient noise, using a sample of ambient noise from the location or location category in which the user equipment 110 is located. With the ambient noise filtered out, the remaining audio input, which may include one or more user utterances, may be processed by the voice and/or speech recognition module 375. Using the optional audio input adjustment module 370, the voice and/or speech recognition module 375 may use a generic voice recognition model since the audio input has already been filtered for the typical ambient noise in the determined location or location category. By way of non-limiting example, means for implementing the machine-readable instruction 335 of the optional audio input adjustment module 370 may include a processor (e.g., 210, 212, 214, 216, 218, 252, 260, 330, 331) of a processing device (e.g., 110, 150), the electronic storage 325, 326, external resources 320, one or more sensor(s) (e.g., microphone 207), and an audio profile database for storing adjusted audio inputs.

The voice and/or speech recognition module 375 may be configured to perform voice and/or speech recognition on the audio input (e.g., user utterances), in particular, the voice and/or speech recognition module 375 may use the voice recognition model determined by the voice recognition model determination module 365 to perform voice and/or speech recognition. The voice recognition model, which is associated with a particular location or location category, may use different parameters for voice and/or speech recognition that may be applied to any received audio inputs for direct voice and/or speech recognition analysis. Alternatively, if the optional audio input adjustment module 370 is included/used, the voice and/or speech recognition module 375 may use a generic voice recognition model or at least one tailored to the particular user, but not the particular location or location category, for voice and/or speech recognition. By way of non-limiting example, means for implementing the machine-readable instruction 335 of the voice and/or speech recognition module 375 may include a processor (e.g., 210, 212, 214, 216, 218, 252, 260, 330, 331) of a processing device (e.g., 110, 150), the electronic storage 325, 326, external resources 320, one or more sensor(s) (e.g., microphone 207), and a voice and/or speech recognition database for storing the results of the voice and/or speech recognition.

The remote computing device(s) 150 may be configured by machine-readable instructions 336, which may include one or more instruction modules. The instruction modules may include computer program modules. In particular, the instruction modules may include one or more of a compiled audio input reception module 380, a user keyword module 385, a location/location category association module 390, a voice recognition model generation module 395, a voice recognition model transmission module 397, and/or other instruction modules.

The audio input reception module 380 may be configured to receive, from the user equipment 110, the audio input, a sample thereof, and/or an audio profile, such as the audio profile compiled by the audio profile compilation module 350. Thus, the audio input reception module 380 may receive ambient noise and/or user keyword utterances, along with location information associated with a location where the ambient noise and/or user keyword utterances were recorded. In some embodiments, the audio input reception module 380 may receive a plurality of ambient noise samples and/or user keyword utterances, each having location information associated with different locations. By way of a non-limiting example, means for implementing the machine-readable instruction 336 of the audio input reception module 380 may include a processor (e.g., 210, 212, 214, 216, 218, 252, 260, 330, 331) of a processing device (e.g., 110, 150), the electronic storage 325, 326, external resources 320, and the transceiver 328 for receiving ambient noise samples or profiles.

The user keyword module 385 may be configured to maintain information about user keyword utterances (i.e., keyword information) used for voice and/or speech recognition. The keyword information may be obtained from samples of keywords spoken by a user contained in the received audio input. The keyword information may identify keywords and include audio characteristics of each keyword, which characteristics may be used to identify the keyword in utterances. Each of the voice recognition models generated by the voice recognition model generation module 395 may be associated with different keywords. Alternatively, the keywords, which may be unique to a particular user, may be associated with all inquiries and commands. By way of non-limiting example, means for implementing the machine-readable instruction 336 of the user keyword module 385 may include a processor (e.g., 210, 212, 214, 216, 218, 252, 260, 330, 331) of a processing device (e.g., 110, 150), the electronic storage 325, 326, external resources 320, one or more sensor(s) (e.g., microphone 207), and a user key word database for use when generating voice recognition models.

The location/location category association module 390 may be configured to determine a location or location category, for the received audio input, audio sample, and/or audio profile, based on the corresponding location information received from the user equipment. By way of non-limiting example, means for implementing the machine-readable instruction 336 of the location/location category association module 390 may include a processor (e.g., 210, 212, 214, 216, 218, 252, 260, 330, 331) of a processing device (e.g., 110, 150) may use the electronic storage 325 326, external resources 320, and location/location category database for determining a location or location category in which ambient noise was recorded.

The voice recognition model generation module 395 may be configured to use the received audio input, audio sample, and/or audio profile to generate a voice recognition model associated with a location or location category for use in voice and/or speech recognition. In some embodiments, the voice recognition model generation module 395 may use samples of keywords spoken by a user contained in the received audio input, which may be used for generating a voice recognition model. in some embodiments, the voice recognition model generation module 395 may use a plurality of audio samples for generating distinct voice recognition models and each having location information associated with different locations. In some embodiments, the voice recognition model generation module 395 may use a plurality of audio samples for generating one voice recognition model associated with a single location or location category. The location(s) or location category/categories associated with each voice recognition model may be the ones determined by the location/location category determination module 345. By way of non-limiting example, means for implementing the machine-readable instruction 336 of the voice recognition model generation module 395 may include a processor (e.g., 210, 212, 214, 216, 218, 252, 260, 330, 331) of a processing device (e.g., 110, 150) may use the electronic storage 325, 326, external resources 320, and a voice recognition model database for accessing information about various voice recognition models and parameters for generating them.

The voice recognition model transmission module 397 may be configured to provide the voice recognition model, generated by the voice recognition model generation module 395 and associated with the location or location category to the user equipment. By way of non-limiting example, means for implementing the machine-readable instruction 336 of the voice recognition model transmission module 397 may include a processor (e.g., 210, 212, 214, 216, 218, 252, 260, 330, 331) of a processing device (e.g., 110, 150), the electronic storage 325, 326, external resources 320, and the transceiver 328 for receiving the voice recognition models.

The user equipment 110 may include one or more processors configured to execute computer program modules similar to those in the machine-readable instructions 336 of the remote computing device(s) 150 described above. By way of non-limiting examples, the user equipment may include one or more of a laptop computer, a handheld computer, a tablet computing platform, a NetBook, a smartphone, a gaming console, and/or other mobile computing platforms.

A given remote computing device(s) 150 may include one or more processors configured to execute computer program modules similar to those in the machine-readable instructions 335 of the user equipment 110 described above. By way of non-limiting examples, remote computing devices may include one or more of a server, desktop computer, a laptop computer, a handheld computer, a tablet computing platform, a NetBook, a smartphone, a gaming console, and/or other computing platforms.

The processor(s) 330, 331 may be configured to execute modules 340, 345, 350, 355. 360, 365, 370, 375, 380, 385, 390, 395, and/or 397, and/or other modules. Processor(s) 330, 331 may be configured to execute modules 340, 345, 350, 355, 360, 365, 370, 375, 380, 385, 390, 395, and/or 397, and/or other modules by software; hardware; firmware; some combination of software, hardware, and/or firmware; and/or other mechanisms for configuring processing capabilities on processor(s) 330, 331. As used herein, the term “module” may refer to any component or set of components that perform the functionality attributed to the module. This may include one or more physical processors during execution of processor readable instructions, the processor readable instructions, circuitry, hardware, storage media, or any other components.

The description of the functionality provided by the different modules 340, 345, 350, 355, 360, 365, 370, 375, 380, 385, 390, 395, and/or 397 described below is for illustrative purposes, and is not intended to be limiting, as any of modules 340, 345, 350, 355, 360, 365, 370, 375, 380, 385, 390, 395, and/or 397 may provide more or less functionality than is described. For example, one or more of modules 340, 345, 350, 355, 360, 365, 370, 375, 380, 385, 390, 395, and/or 397 may be eliminated, and some or all of its functionality may be provided by other ones of modules 340, 345, 350, 355, 360, 365, 370, 375, 380, 385, 390, 395, and/or 397. As another example, processor(s) 330 may be configured to execute one or more additional modules that may perform some or all of the functionality attributed below to one of modules 340, 345, 350, 355, 360, 365, 370, 375, 380, 385, 390, 395, and/or 397.

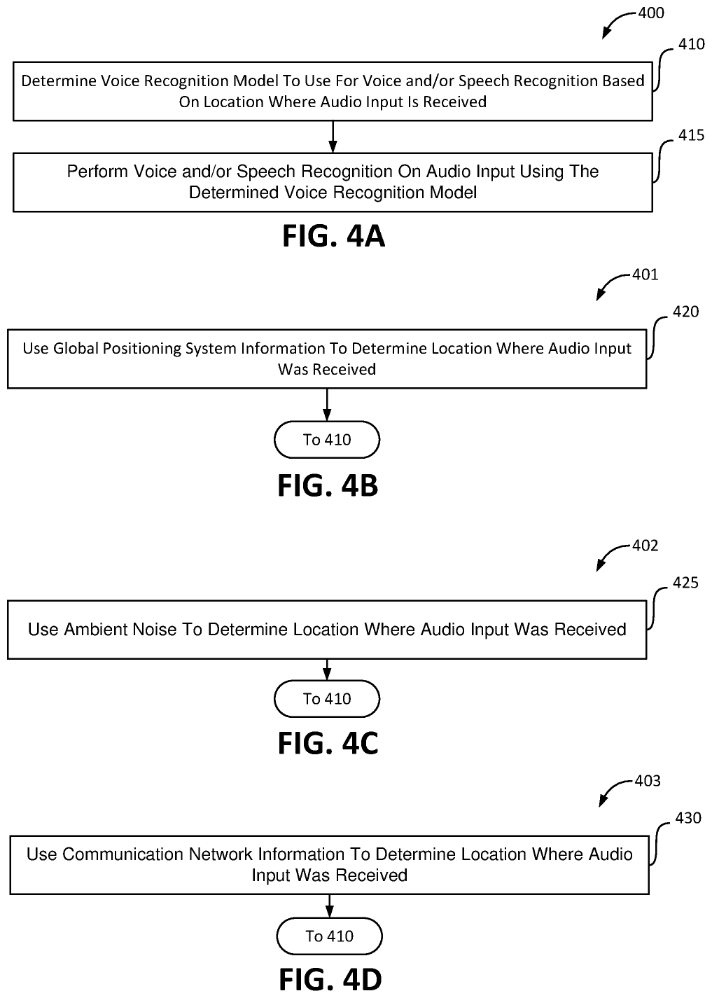

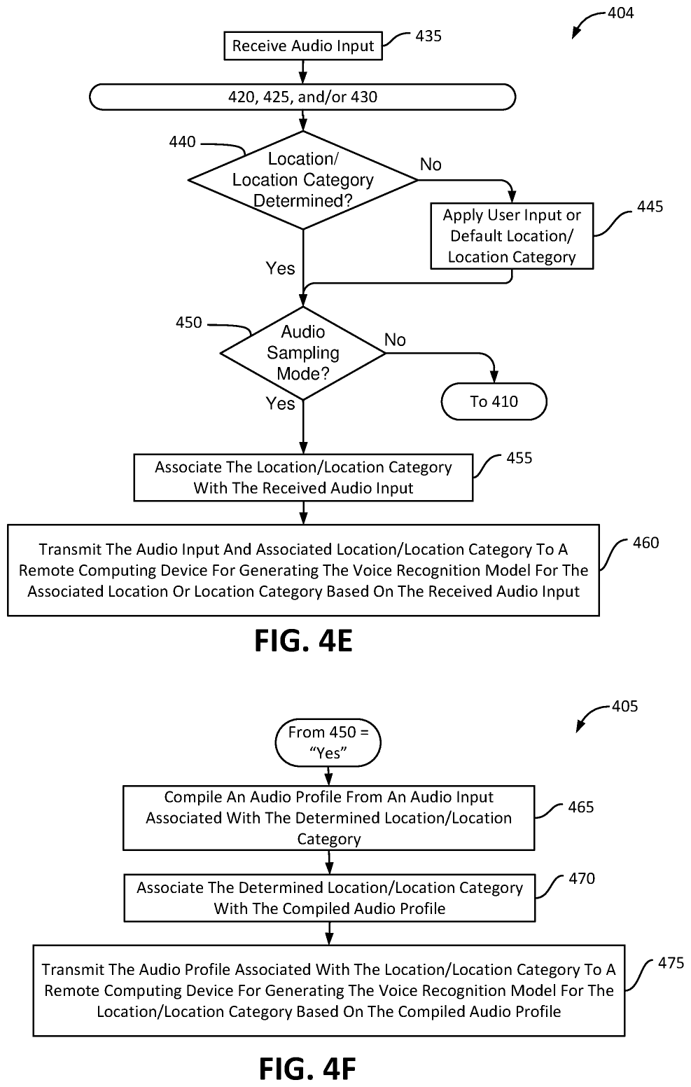

FIGS. 4A, 4B, 4C, 41), 4E, and/or 4F illustrate(s) operations of methods 400, 401, 402, 403, 404, and/or 405 for voice and/or speech recognition executed by a processor of a computing device in accordance with various embodiments. With reference to FIGS. 1-4A, 4B, 4C, 4D, 4E, and/or 4F, the operations of the methods 400, 401, 402, 403, 404, and/or 405 presented below are intended to be illustrative. In some embodiments, methods 400, 401, 402, 403, 404, and/or 405 may be accomplished with one or more additional operations not described, and/or without one or more of the operations discussed. Additionally, the order in which the operations of the methods 400, 401, 402, 403, 404, and/or 405 are illustrated in FIGS. 4A, 4B, 4C, 4D, 4E, and/or 4F and described below is not intended to be limiting.

In some embodiments, the methods 4A, 4B, 4C, 4D, 4E, and/or 4F may be implemented in one or more processors (e.g., a digital processor, an analog processor, a digital circuit designed to process information, an analog circuit designed to process information, a state machine, and/or other mechanisms for electronically processing information) in response to instructions stored electronically on an electronic storage medium of a computing device. The one or more processors may include one or more devices configured through hardware, firmware, and/or software to be specifically designed for execution of one or more of the operations of the methods 400, 401, 402, 403, 404, and/or 405. For example, with reference to FIGS. 4B, 4C, 4D, 4E, and/or 4F, the operations of the methods 400, 401, 402, 403, 404, and/or 405 may be performed by a processor (e.g., 210, 21.2, 214, 216, 218, 252, 260, 330, 331) of a computing device (e.g., 110, 150).

FIG. 4A illustrates the method 400, in accordance with one or more implementations.

in block 410, the processor of a computing device may perform operations including determining a voice recognition model to use for voice and/or speech recognition based on a location where an audio input is received. In block 410, the processor of the user equipment may use the audio receiving module (e.g., 340), the location/location-category determination module (e.g., 345), and the voice recognition model determination module 365 to select an appropriate voice recognition model based on a location or location category at which the audio input was received/recorded. For example, the processor may determine that a currently received utterance was spoken at a user's home. In this case, a voice recognition model trained to consider the ambient noise in the user's home may more accurately translate speech and/or identify/authenticate a user from the sound of their voice. As another example, the processor may determine that a currently received utterance was spoken at a restaurant. In this case, restaurants may fall under a location category for which a crowd sourced audio profile may have been used to generate a voice recognition model that may more accurately translate speech and/or identify/authenticate a user. In some embodiments, means for performing the operations of block 410 may include a processor 210, 212, 214, 216, 218, 252, 260, 330, 331) coupled to a microphone (e.g., 207), electronic storage (e.g., 325, 326), external resources (e.g., 320), and the voice recognition model determination module (e.g., 365).

In block 415, the processor of a computing device may perform operations including performing voice and/or speech recognition on the audio input using the determined voice recognition model. In block 415, the processor of the user equipment may perform voice and/or speech recognition using an appropriate voice recognition model that was selected to better account for background ambient noise. For example, where the received audio input was collected from the user's home, some regular background noises like people conversing, children and/or music playing, noisy appliances running, at the like may have already been taken into account when generating the voice recognition model selected to perform voice and/or speech recognition. Alternatively, the processor may use the voice recognition model to adjust the received audio input for predicted ambient noise for that environment (i.e., location and/or location category). In this way, the regular background noise may be filtered out of the received audio input before a more generic model (i.e., even one customized to the particular user) is used for voice and/or speech recognition. In some embodiments, means for performing the operations of block 415 may include a processor (e.g., 210, 212, 214, 216, 218, 252, 260, 330, 331) coupled to electronic storage (e.g., 325, 326), external resources (e.g., 320), and the voice and/or speech recognition module (e.g., 375).

In some embodiments, the processor may repeat any or all of the operations in blocks 410 and 415 to repeatedly or continuously to perform voice and/or speech recognition.

FIG. 4B illustrates method 401 that may be perform with or as an enhancement to the method 400.

In block 420, the processor of a computing device may perform operations including using global positioning system (GPS) information to determine the location where an audio input is received. In block 420, the processor of the user equipment may use the audio receiving module (e.g., 340) and the location/location-category determination module (e.g., 345) to determine the location where the audio input was received/recorded. For example, the processor may access GPS systems, providing coordinates, an address, or other location information. In addition, the processor may access one or more online databases that may identify a location that corresponds to the GPS information. Further, using contact information stored in the user equipment, the location may be more accurately associated with the user's home, office, or other frequented location. In some embodiments, means for performing the operations of block 420 may include a processor (e.g., 2110, 212, 214, 216, 218, 252, 260, 330, 331) coupled to a wireless transceiver (e.g., 208), electronic storage (e.g., 325, 326), external resources (e.g., 320), and the location/location category determination module (e.g., 345). Following the operations in block 420, the processor may determine a voice recognition model to use for voice and/or speech recognition based on the determined location where the audio input is received in block 410.

In some embodiments, the processor may repeat any or all of the operations in blocks 410, 415, and 420 to repeatedly or continuously to perform voice and/or speech recognition.

FIG. 4C illustrates method 402 that may be perform with or as an enhancement to the method 400.

In block 425, the processor of a computing device may perform operations including using ambient noise to determine the location where the audio input is received. In block 425 the processor of the user equipment may use the audio receiving module (e.g., 340) and the location/location-category determination module (e.g., 345) to determine the location where the audio input was received/recorded. For example, the processor may compare ambient noise included in the received audio input to ambient noise samples stored in memory. If the currently received ambient noise matches an ambient noise sample, the processor may assume the current location is that location associated with the matching ambient noise sample. In some embodiments, means for performing the operations of block 425 may include a processor (e.g., 210, 212, 214, 216, 218, 252, 260, 330, 331) coupled to a wireless transceiver (e.g., 208), electronic storage (e.g., 325, 326), external resources (e.g., 320), and the location/location category determination module (e.g., 345). Following the operations in block 425, the processor may determine a voice recognition model to use for voice and/or speech recognition based on the determined location where the audio input is received in block 410.

In some embodiments, the processor may repeat any or all of the operations in blocks 410. 415, and 425 to repeatedly or continuously to perform voice and/or speech recognition.

FIG. 4D illustrates method 403 that may be perform with or as an enhancement to the method 400.

In block 430, the processor of a computing device may perform operations including using communication network information to determine the location where the audio input is received. In block 430, the processor of the user equipment may use the wireless transceiver 208, the audio receiving module (e.g., 340), and the location/location-category determination module (e.g., 345) to determine the location where the audio input was received/recorded. For example, the processor may check a current local network connection, such as to a WiFi, Bluetooth, or other wireless network that is trusted, with connection settings saved in electronic storage (e.g., 325). Such saved local network connections may be associated with a location, such as a user's home, work, gym, etc. Thus, by identifying a current local network connection as one saved in memory and for which the location is known, the processor may use communication network information to determine a current location where the audio input is received. In some embodiments, means for performing the operations of block 430 may include a processor (e.g., 210, 212, 214, 216, 218, 252, 260, 330, 331) coupled to a wireless transceiver (e.g., 208), electronic storage (e.g., 325, 326), external resources (e.g., 320), and the location/location category determination module (e.g., 345). Following the operations in block 430, the processor may determine a voice recognition model to use for voice and/or speech recognition based on the determined location where the audio input is received in block 410.

In some embodiments, the processor may repeat any or all of the operations in blocks 410, 415, and 430 to repeatedly or continuously to perform voice and/or speech recognition.

FIG. 4E illustrates method 404 that may be perform with or as an enhancement to the method 400.

In block 435, the processor of a computing device may receive an audio input. In block 435 the processor of the user equipment may use the audio receiving module (e.g., 340) to receive the audio input. In some embodiments, means for performing the operations of block 435 may include a processor (e.g., 210, 212, 214, 216, 218, 252, 260, 330, 331) coupled to a microphone (e.g., 20), electronic storage (e.g., 325, 326), external resources (e.g., 320), and the audio receiving module (e.g., 340). Following the operations in block 435, the processor may perform the operations in one or more of blocks 420, 425, and 430 to determine a location where the audio input was received. The choice of which operational blocks to perform. (i.e., 420, 425, and/or 430) may be based on availability of those corresponding resources and/or information likely to determine the location or a location category.

In determination block 440, the processor of a computing device may determine whether a location or location category of the received audio input has been determined. In other words, was the location or location category determined by the operations in one or more of blocks 420, 425, and 430? In some embodiments, means for performing the operations of determination block 440 may include a processor (e.g., 210, 212, 214, 216, 218, 252, 260, 330, 331) coupled to electronic storage (e.g., 325, 326), external resources (e.g., 320), and the location/location category determination module (e.g., 345).

In response to the processor determining that the location or location category of the received audio input has been determined (i.e., determination block 440 =“Yes”), the processor may determine whether the received audio input is part of an audio sampling mode in determination block 450. In some embodiments, the user equipment may operate in at least one of two modes, namely an audio sampling mode and a voice/speech recognition mode. The audio sampling mode may be used to train the system (e.g., 300) with one or more ambient noise samples or user utterances of keywords or expressions from a particular location, in order to compile a customized voice recognition model. The voice/speech recognition mode may be used to authenticate/identify a speaker of an utterance (i.e., voice recognition) and/or perform speech recognition (i.e., transcribe speech into text and/or recognize and execute verbal commands).

In response to the processor determining that location or location category of the received audio input has not been determined (i.e., determination block 440=“No”), the processor may apply a user input or default location/location category in block 445.

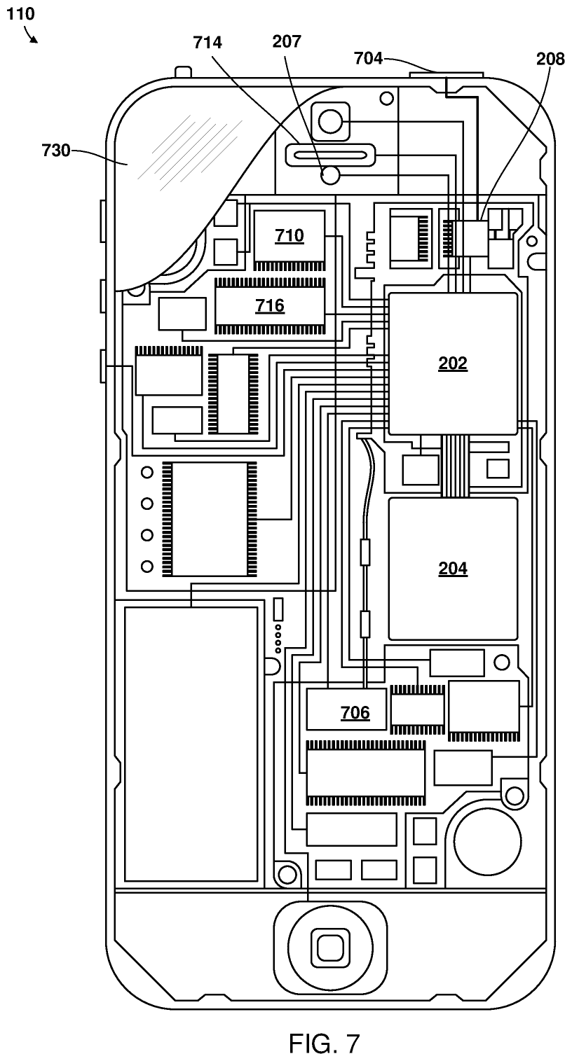

in block 445, having determined that a location or location category for the received audio input in unknown, the processor of a computing device may access a memory buffer to check whether a user input in this regard has been received. For example, before speaking an utterance, the user (e.g., 11) of the user equipment may have entered location information into a field or pop-up screen made available for that purpose. Similarly, the user equipment may have a default location stored for all or select circumstances in which audio inputs are received and/or analyzed. In this way, the processor may apply the location information either entered by the user or set as a default location as a location or location category of the audio input received in block 435. Optionally, if no location or location category is determined and a default location or location category needs to be used, the failure to determine a location or location category may be reported to an equipment manufacturer of the user equipment, communications provider, or other entity, in an error reporting process. Alternatively, the processor may prompt the user for a location and apply the response to the prompt as the location. The prompt may include suggestions, such as a list of recent or favorite locations, a default location, or others. A user response to the prompt may be treated as the user input providing the location or location category. In some embodiments, means for performing the operations of block 445 may include a processor (e.g., 210, 212, 214, 216, 218, 252, 260, 330, 331) coupled to a user interface (e.g., display 730 in FIG. 7), electronic storage (e.g., 325, 326), external resources (e.g., 320), and the location/location category determination module (e.g., 345).

In determination block 450, the processor may determine whether the received audio input is part of the audio sampling mode. The audio sampling mode may be part of a training routine used by the system (e.g., 300) to collect ambient noise samples and/or keyword utterances from the user equipment at one or more locations. In the audio sampling mode, the user may be asked not to speak while recording the sounds naturally heard in the sampling location. The audio sampling mode may require multiple recordings (i.e., samples) from the same location, to detect consistent patterns and/or filter out anomalous sounds that may occur during sampling. In some embodiments, means for performing the operations of determination block 450 may include a processor (e.g., 210, 212, 214, 216, 218, 252, 260, 330, 331) coupled to electronic storage (e.g., 325, 326), external resources (e.g., 320), and the audio receiving module (e.g., 340).

In response to determining that the received audio input is part of the audio sampling mode (i.e., determination block 450=“Yes”), the processor may associate the determined location or location category with the received audio input in block 455, as part of the audio sampling mode. The audio sampling mode may include acquiring, saving and/or transmitting ambient noise samples and/or keyword utterances at a particular location that can be used to train or compile a customized voice recognition model for the particular location.

In response to the processor determining that the received audio input is not part of the audio sampling mode (i.e., determination block 450=“No”), the processor may determine a voice recognition model to use for voice and/or speech recognition based on the determined location where the audio input is received in block 410, as part of a voice/speech recognition mode. The voice/speech recognition mode may be used for voice and/or speech recognition.

In block 455, the processor of a computing device may associate the determined location or location category with the received audio input. Whether the location was determined in blocks 420, 425, and/or 430, determined from a user input in block 445, or determined from a default location/location category in block 445, that determination may be stored in memory and/or made a part of an ambient noise sample (e.g., attached through metadata). In some embodiments, means for performing the operations of block 455 may include a processor (e.g., 210, 212, 214, 216, 218, 252, 260, 330, 331) coupled to electronic storage (e.g., 325, 326), external resources (e.g., 320), and the ambient noise sample/profile compilation module (e.g., 350).

in block 460, the processor of a computing device may transmit the audio input and associated location or location category information to a remote computing device for generating the voice recognition model for the associated location or location category. For example, the processor may use the wireless transceiver (e.g., 208), to transmit an ambient noise sample associated with a location in block 455 to the remote computing device 150 via a communication network (e.g., 50). In some embodiments, means for performing the operations of block 460 may include a processor (e.g., 210, 212, 214, 216, 218, 252, 260, 330, 331) coupled to the wireless transceiver (e.g., 208), electronic storage (e.g., 325, 326), external resources (e.g., 320), and the audio input transmission module (e.g., 355).

In some embodiments, the processor may repeat any or all of the operations in blocks 410, 415, 420, 425, 430, 445, 455, and 460, as well as determination blocks 440 and 450 to repeatedly or continuously to perform voice and/or speech recognition.

FIG. 4F illustrates method 400 that may be perform with or as an enhancement to the method 404.

In block 465, the processor of a computing device may perform operations including compiling an audio profile from an audio input associated with the determined location or location category. For example, the audio profile may include characteristics or other information associated with the received audio input, including location and/or location category information. In some embodiments, means for performing the operations of block 465 may include a processor (e.g., 210, 212, 214, 216, 218, 252, 260, 330, 331) coupled to the electronic storage (e.g., 325, 326), external resources (e.g., 320), and the ambient noise sample/profile compilation module (e.g., 350).

In block 470, the processor of a computing device may perform operations including associating the determined location and/or a location category with the compiled audio profile. Whether the location was determined in blocks 420, 425, and/or 430 of methods 401, 402, 403, determined from a user input in block 445 of the method 404, or determined from a default location/location category in block 445, that determination may be stored in memory and/or made a part of an audio profile. In some embodiments, means for performing the operations of block 455 may include a processor (e.g., 1.0, 212, 214, 216, 218, 252, 260, 330, 331) coupled to electronic storage (e.g., 325, 326), external resources (e.g., 320), and the ambient noise sample/profile compilation module (e.g., 350).

In block 475, the processor of a computing device may perform operations including transmitting the audio profile associated with the location and/or location category to a remote computing device for generating the voice recognition model for the location and/or location category based on the compiled audio profile. For example, the processor may use the wireless transceiver (e.g., 208), to transmit the audio profile compiled in block 465 to the remote computing device 150 via a communication network (e.g., 50). In some embodiments, means for performing the operations of block 460 may include a processor (e.g., 210, 212, 214, 216, 218, 252, 260, 330, 331) coupled to the wireless transceiver (e.g., 208), electronic storage (e.g., 325, 326), external resources (e.g., 320 and the audio input transmission module (e.g., 355).

In some embodiments, the processor may repeat any or all of the operations in blocks 410, 415, 420, 425, 430, 445, 465, 470, and 475, as well as determination blocks 440 and 450 to repeatedly or continuously to perform voice and/or speech recognition.

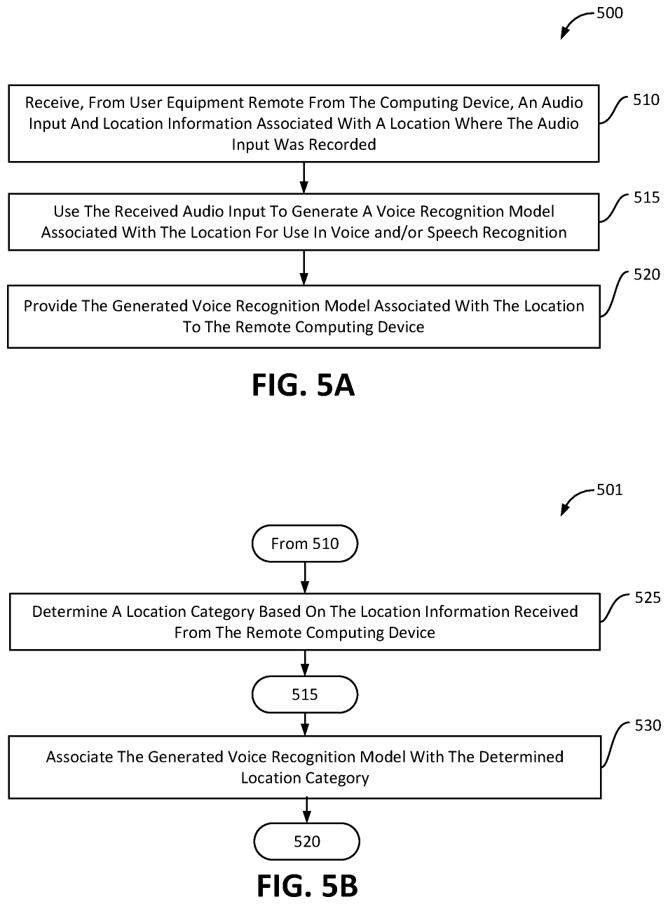

FIGS. 5A and 5B illustrate operations of methods 500 and 501 for voice and/or speech recognition executed by a processor of a computing device in accordance with some embodiments. With reference to FIGS. 1-5B, the operations of the methods 500 and 501 presented below are intended to be illustrative. In some embodiments, methods 500 and 501 may be accomplished with one or more additional operations not described, and/or without one or more of the operations discussed. Additionally, the order in which the operations of the methods 500 and/or 501 are illustrated in FIGS. 5A and SB and described below is not intended to be limiting.

In some embodiments, the methods 5A and 513 may be implemented in one or more processors (e.g., a digital processor, an analog processor, a digital circuit designed to process information, an analog circuit designed to process information, a state machine, and/or other mechanisms for electronically processing information) in response to instructions stored electronically on an electronic storage medium of a computing device. The one or more processors may include one or more devices configured through hardware, firmware, and/or software to be specifically designed for execution of one or more of the operations of the methods 500 and 501. For example, with reference to FIGS. 1-5B, the operations of the methods 500 and 501 may be performed by a processor (e.g., 210, 212, 214, 216, 218, 252, 260, 330, 331) of a computing device (e.g., 110, 150).

Referring to FIG. 5A block 510, the processor of a computing device (e.g., remote computing device 150) may perform operations including receiving, from the user equipment (e.g., 110) remote from the computing device (e.g., 150), an audio input and location information associated with a location where the audio input was recorded. The received audio may be part of a plurality of received audio inputs each having location information associated with different locations. In block 510, the processor of the remote computing device may use an audio input reception module (e.g., 380), a user keyword module (e.g., 385), and a location/location category association module (e.g., 390). For example, after the user equipment collects and sends an audio input to the remote computing device, the processor of the remote computing device may receive the collected ambient noise sample. In some embodiments, means for performing the operations of block 510 may include a processor (e.g., 210, 212, 214, 216, 218, 252, 260, 330, 331) coupled to a transceiver (e.g., 328), electronic storage (e.g., 326), external resources (e.g., 320), and the ambient noise sample/profile reception module (e.g., 380).

In block 515, the processor of the remote computing device may perform operations including using the received audio input to generate a voice recognition model associated with the location for use in voice and/or speech recognition. For example, where the received audio input was collected from the user's home or business office, some regular background noises like phones ringing, machinery, people talking, etc., may be taken into account when generating a voice recognition model for that environment. The generated voice recognition model may be configured to be used to adjust the received audio input for predicted ambient noise for that environment location and/or location category). In this way, the regular background noise may be filtered out of the received audio input before a more generic model (i.e., even one customized to the particular user) is used for voice and/or speech recognition. In some embodiments, a plurality of received ambient noise samples may be used to generate voice recognition models, such that each of the generated voice recognition models may be configured to be used at a respective one of the different locations. In some embodiments, means for performing the operations of block 515 may include a processor (e.g., 210, 212, 214, 216 218, 252, 260, 330, 331) coupled to electronic storage (e.g., 325, 326), external resources (e.g., 320), and the voice recognition model generation module (e.g., 395).

In block 520, the processor of the remote computing device may perform operations including providing (i.e., transmitting) the generated voice recognition model associated with the location to a remote computing device, such as a user equipment. For example, after the remote computing device generates the voice recognition model in block 515, that voice recognition model may be sent to the user equipment. In some embodiments, means for performing the operations of block 520 may include a processor (e.g., 210, 212, 214, 216, 218, 252, 260, 330, 331) coupled to a transceiver (e.g., 328), electronic storage (e.g., 326), external resources (e.g., 320), and the voice recognition model transmission module (e.g., 380).

In some embodiments, the processor may repeat any or all of the operations in blocks 510, 515, and 520 to repeatedly or continuously to perform voice and/or speech recognition.

FIG. 5B illustrates method 501 that may be perform as part of or as an improvement to the method 500.

In block 525, following the operations in block 510 of the method 500, the processor of a remote computing device may perform operations including determining a location category (of the audio sample) based on the location information received from the user equipment. In block 525, the processor of the remote computing device may use the location/location category association module (e.g., 390) to determine the location of where the audio input was received/recorded. For example, the processor may identify a location that corresponds to GPS information, ambient noise location identification information, and/or communication network information. In some embodiments, means for performing the operations of block 525 may include a processor (e.g., 210, 212, 214, 216, 218, 252, 260, 330, 331) coupled to electronic storage (e.g., 325, 326), external resources (e.g., 320), and the location/location category determination module (e.g., 345). Following the operations in block 525, the processor may use the received audio input to generate a voice recognition model associated with the location for use in voice and/or speech recognition in block 515.

In block 530, following the operations in block 515, the processor of a remote computing device may perform operations including associating the generated voice recognition model with the determined location category. For example, if the received audio input is associated with a category of locations, such as “church,” then the voice recognition model generated from that audio input will also be associated with a church location category. In some embodiments, means for performing the operations of block 530 may include a processor (e.g., 210, 212, 214, 216, 218, 252, 260, 330, 331) coupled to electronic storage (e.g., 325, 326), external resources (e.g., 320), and the location/location category determination module (e.g., 345).

in some embodiments, the processor may repeat any or all of the operations in blocks 510, 515, 520, 525, and 530 to repeatedly or continuously to perform voice and/or speech recognition.

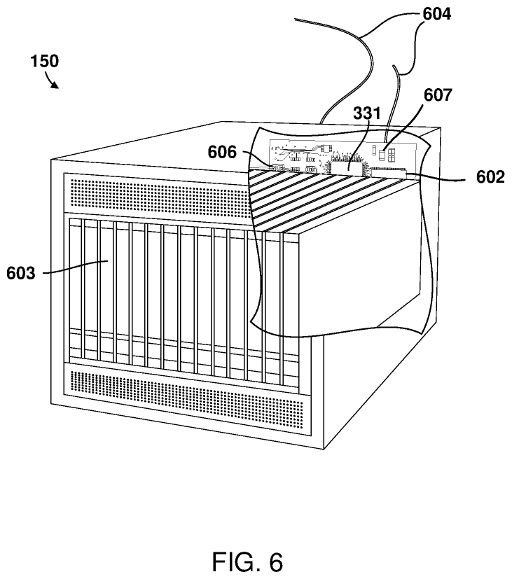

Various embodiments (including, but not limited to, embodiments discussed above with reference to FIGS. 15B) may be implemented on a variety of remote computing devices, an example of which is illustrated in FIG. 6 in the form of a server, With reference to FIGS. 1-6, the remote computing device 150 may include a processor 331 coupled to volatile memory 602 and a large capacity nonvolatile memory, such as a disk drive 603. The network computing device 150 may also include a peripheral memory access device such as a floppy disc drive, compact disc (CD) or digital video disc (DVD) drive 606 coupled to the processor 331. The remote computing device 150 may also include network access ports 604 (or interfaces) coupled to the processor 331 for establishing data connections with a network, such as the Internet and/or a local area network coupled to other system computers and servers. The remote computing device 150 may include one or more antennas 607 for sending and receiving electromagnetic radiation that may be connected to a wireless communication link. The remote computing device 150 may include additional access ports, such as USB, Firewire, Thunderbolt, and the like for coupling to peripherals, external memory, or other devices.

The various aspects (including, but not limited to, embodiments discussed above with reference to FIGS. 1-5B) may be implemented on a variety of user equipment, an example of which is illustrated in FIG. 7 in the form of a mobile computing device. With reference to FIGS. 1-7, the user equipment 110 may include a first SoC 202 (e.g., a SoC-CPU) coupled to a second SoC 204 (e.g., a 5G capable SoC) and a third SoC 706 (e.g., a C-V2X SoC configured for managing V2V, V2I, and V2P communications over D2D links, such as D2D links establish in the dedicated intelligent Transportation System (ITS) 5.9 GHz spectrum communications). The first, second, and/or third SoCs 202, 204, and 706 may be coupled to internal memory 716, a display 730, a speaker 714, a microphone 207, and a wireless transceiver 208. Additionally, the mobile computing device 110 may include one or more antenna 704 for sending and receiving electromagnetic radiation that may be connected to the wireless transceiver 208 (e.g., a wireless data link and/or cellular transceiver, etc.) coupled to one or more processors in the first, second, and/or third SoCs 202, 204, and 706. Mobile computing devices 110 may also include menu selection buttons or switches for receiving user inputs.

Mobile computing devices 110 may additionally include a sound encoding/decoding (CODEC) circuit 710, which digitizes sound received from the microphone 207 into data packets suitable for wireless transmission and decodes received sound data packets to generate analog signals that are provided to the speaker to generate sound and analyze ambient noise or speech. Also, one or more of the processors in the first, second, and/or third SoCs 202, 204, and 706, wireless transceiver 208 and CODEC circuit 710 may include a digital signal processor (DSP) circuit (not shown separately).

The processors implementing various embodiments may be any programmable microprocessor, microcomputer or multiple processor chip or chips that can be configured by software instructions (applications) to perform a variety of functions, including the functions of the various aspects described in this application. in some communication devices, multiple processors may be provided, such as one processor dedicated to wireless communication functions and one processor dedicated to running other applications. Typically, software applications may be stored in the internal memory before they are accessed and loaded into the processor. The processor may include internal memory sufficient to store the application software instructions.

As used in this application, the terms “component” “module,” “system,” and. the like are intended to include a computer-related. entity, such as, but not limited to, hardware, firmware, a combination of hardware and software, software, or software in execution, which are configured to perform particular operations or functions. For example, a component may be, but is not limited to, a process running on a processor, a processor, an object, an executable, a thread of execution, a program, and/or a computer. By way of illustration, both an application running on a processor of a communication device and the communication device may be referred to as a component. One or more components may reside within a process and/or thread of execution and a component may be localized on one processor or core and/or distributed between two or more processors or cores. In addition, these components may execute from various non-transitory computer readable media having various instructions and/or data structures stored thereon. Components may communicate by way of local and/or remote processes, function or procedure calls, electronic signals, data packets, memory read/writes, and other known network, computer, processor, and/or process related communication methodologies.

A number of different cellular and mobile communication services and standards are available or contemplated in the future, all of which may implement and benefit from the various aspects. Such services and standards may include, e.g., third generation partnership project (3GPP), long term evolution (LTE) systems, third generation wireless mobile communication technology (3G), fourth generation wireless mobile communication technology (4G), fifth generation wireless mobile communication technology (5G) global system for mobile communications (GSM), universal mobile telecommunications system (UMTS), 3GSM, general packet radio service (CPRS), code division multiple access (CDMA) systems (e.g., cdmaOne, CDMA 1020TM) EDGE, advanced mobile phone system (AMPS), digital AMPS (IS-136/TDMA), evolution-data optimized (EV-DO), digital enhanced cordless telecommunications (DECT), Worldwide Interoperability for Microwave Access (WiMAX), wireless local area network (WLAN), Wi-Fi Protected Access I & Il (WPA, WPA2), integrated digital enhanced network (idea), CV2X, V2V, V2P, V2I, and V2N, etc. Each of these technologies involves, for example, the transmission and reception of voice, data, signaling, and/or content messages. It should be understood that any references to terminology and/or technical details related to an individual telecommunication standard or technology are for illustrative purposes only, and are not intended to limit the scope of the claims to a particular communication system or technology unless specifically recited in the claim language.

Various aspects illustrated and described are provided merely as examples to illustrate various features of the claims. However, features shown and described with respect to any given aspect are not necessarily limited to the associated aspect and may be used or combined with other aspects that are shown and described. Further, the claims are not intended to be limited by any one example aspect. For example, one or more of the operations of the methods may be substituted for or combined with one or more operations of the methods.

The foregoing method descriptions and the process flow diagrams are provided merely as illustrative examples and are not intended to require or imply that the operations of various aspects must be performed in the order presented. As will be appreciated by one of skill in the art the order of operations in the foregoing aspects may be performed in any order. Words such as “thereafter,” “then,” “next,” etc. are not intended to limit the order of the operations; these words are used to guide the reader through the description of the methods. Further, any reference to claim elements in the singular, for example, using the articles “a,” “an,” or “the” is not to be construed as limiting the element to the singular.

Various illustrative logical blocks, modules, components, circuits, and algorithm operations described in connection with the aspects disclosed herein may be implemented as electronic hardware, computer software, or combinations of both. To clearly illustrate this interchangeability of hardware and software, various illustrative components, blocks, modules, circuits, and operations have been described above generally in terms of their functionality. Whether such functionality is implemented as hardware or software depends upon the particular application and design constraints imposed on the overall system. Skilled artisans may implement the described functionality in varying ways for each particular application, but such aspect decisions should not be interpreted as causing a departure from the scope of the claims.

The hardware used to implement various illustrative logics, logical blocks, modules, and circuits described in connection with the aspects disclosed herein may be implemented or performed with a general purpose processor, a digital signal processor (DSP), are ASIC, a field programmable gate array (FPGA) or other programmable logic device, discrete gate or transistor logic, discrete hardware components, or any combination thereof designed to perform the functions described herein. A general-purpose processor may be a microprocessor, but, in the alternative, the processor may be any conventional processor, controller, microcontroller, or state machine. A processor may also be implemented as a combination of receiver smart objects, e.g., a combination of a DSP and a microprocessor, a plurality of microprocessors, one or more microprocessors in conjunction with a DSP core, or any other such configuration. Alternatively, some operations or methods may be performed by circuitry that is specific to a given function.

In one or more aspects, the functions described may be implemented in hardware, software, firmware, or any combination thereof. If implemented in software, the functions may be stored as one or more instructions or code on a non- transitory computer-readable storage medium or non-transitory processor-readable storage medium. The operations of a method or algorithm disclosed herein may be embodied in a processor-executable software module or processor-executable instructions, which may reside on a non-transitory computer-readable or processor-readable storage medium. Non-transitory computer-readable or processor-readable storage media may be any storage media that may be accessed by a computer or a processor. By way of example but not limitation, such non transitory computer-readable or processor-readable storage media may include RAM, ROM, EEPROM, FLASH memory, CD-ROM or other optical disk storage, magnetic disk storage or other magnetic storage smart objects, or any other medium that may be used to store desired program code in the form of instructions or data structures and that may be accessed by a computer. Disk and disc, as used herein, includes compact disc (CD), laser disc, optical disc, digital versatile disc (DVD), floppy disk, and Blu-ray disc where disks usually reproduce data magnetically, while discs reproduce data optically with lasers. Combinations of the above are also included within the scope of non-transitory computer-readable and processor-readable media. Additionally, the operations of a method or algorithm may reside as one or any combination or set of codes and/or instructions on a non-transitory processor-readable storage medium and/or computer-readable storage medium, which may be incorporated into a computer program product.

The preceding description of the disclosed aspects is provided to enable any person skilled in the art to make or use the claims. Various modifications to these aspects will be readily apparent to those skilled in the art, and the generic principles defined herein may be applied to other aspects without departing from the scope of the claims. Thus, the present disclosure is not intended to be limited to the aspects shown herein but is to be accorded the widest scope consistent with the following claims and the principles and novel features disclosed herein.

What is claimed is:

1. A method of voice or speech recognition executed by a processor of a computing device, comprising:
determining a voice recognition model to use for voice or speech recognition based on a location where an audio input is received; and
performing voice or speech recognition on the audio input using the determined voice recognition model.

2. The method of claim 1, further comprising:
using global positioning system information to determine the location where the audio input is received.

3. The method of claim 1, further comprising:
using ambient noise to determine the location where the audio input is received.

4. The method of claim 1, further comprising:
using communication network information to deter nine the location where the audio input is received.

5. The method of claim 1, wherein determining a voice recognition model to use for voice or speech recognition comprises:
selecting the voice recognition model from a plurality of voice recognition models, wherein each of the plurality of voice recognition models is associated with a different scene category each having a designated audio profile.

6. The method of claim 1, wherein performing voice or speech recognition on the audio input using the determined voice recognition model comprises:
using the determined voice recognition model to adjust the audio input for ambient noise; and
performing voice and/or speech recognition on the adjusted audio input.

7. The method of claim 1, further comprising:
receiving an audio input associated with ambient noise sampling at the location;
associating the location or a location category with the received audio input; and
transmitting the audio input and associated location or location category information to a remote computing device for generating the voice recognition model for the associated location or location category based on the received audio input.

8. The method of claim 1, further comprising:
compiling an audio profile from an audio input associated with ambient noise at the location;
associating the location or a location category with the compiled audio profile; and
transmitting the audio profile associated with the location or location category to a remote computing device for generating the voice recognition model for the location or location category based on the compiled audio profile,

9. A computing device, comprising:
a microphone;
a memory; and
a processor coupled to the microphone and the memory, and configured with processor-executable instructions to:
determine a voice recognition model to use for voice or speech recognition based on a location where an audio input is received via the microphone; and
perform voice or speech recognition on the audio input using the determined voice recognition model.

10. The computing device of claim 9, further comprising a global positioning system receiver,
wherein the processor is further configured with processor-executable instructions to use global positioning system information to determine the location where the audio input is received.

11. The computing device of claim 9, wherein the processor is further configured with processor-executable instructions to use ambient noise to determine the location where the audio input is received.

12. The computing device of claim 9, wherein the processor is further configured with processor-executable instructions to use communication network info nation to determine the location where the audio input is received.

13. The computing device of claim 9, wherein the processor is further configured with processor-executable instructions to determine a voice recognition model to use for voice or speech recognition by:
selecting the voice recognition model from a plurality of voice recognition models stored in the memory, wherein each of the plurality of voice recognition models is associated with a different scene category each having a designated audio profile.

14. The computing device of claim 9, wherein the processor is further configured with processor-executable instructions to perform voice or speech recognition on the audio input using the determined voice recognition model by:
using the determined voice recognition model to adjust the audio input for ambient noise; and
performing voice and/or speech recognition on the adjusted audio input.

15. The computing device of claim 9, wherein the processor is further configured with processor-executable instructions to:
receive, via the microphone, an audio input associated with ambient noise sampling at the location;
associate the location or a location category with the received audio input; and
transmit the audio input and associated location or location category information to a remote computing device for generating the voice recognition model for the associated location or location category based on the received audio input.

16. The computing device of claim 9, wherein the processor is further configured with processor-executable instructions to:
compile an audio profile from an audio input associated with ambient noise at the location;
associate the location or a location category with the compiled audio profile; and
transmit the audio profile associated with the location or location category to a remote computing device for generating the voice recognition model for the location or location category based on the compiled audio profile.

17. A non-transitory processor-readable medium having stored thereon processor-executable instructions configured to cause a processor of a computing device to perform operations comprising:
determining a voice recognition model to use for voice or speech recognition based on a location where an audio input is received; and
performing voice or speech recognition on the audio input using the determined voice recognition model.

18. The non-transitory processor-readable medium of claim 17, wherein the stored processor-executable instructions are configured to cause a processor of a computing device to perform operations further comprising:
using global positioning system information to determine the location where the audio input is received.

19. The non-transitory processor-readable medium of claim 17, wherein the stored processor-executable instructions are configured to cause a processor of a computing device to perform operations further comprising:
using ambient noise to determine the location where the audio input is received.

20. The non-transitory processor-readable medium of claim 17, wherein the stored processor-executable instructions are configured to cause a processor of a computing device to perform operations further comprising:
using communication network information to determine the location where the audio input is received.

21. The non-transitory processor-readable medium of claim 17, wherein the stored processor-executable instructions are configured to cause a processor of a computing device to perform operations such that determining a voice recognition model to use for voice or speech recognition comprises:
selecting the voice recognition model from a plurality of voice recognition models, wherein each of the plurality of voice recognition models is associated with a different scene category each having a designated audio profile.

22. The non-transitory processor-readable medium of claim 17, wherein the stored processor-executable instructions are configured to cause a processor of a computing device to perform operations such that performing voice or speech recognition on the audio input using the determined voice recognition model comprises:
using the determined voice recognition model to adjust the audio input for ambient noise; and
performing voice and/or speech recognition on the adjusted audio input.

23. The non-transitory processor-readable medium of claim 17, wherein the stored processor-executable instructions are configured to cause a processor of a computing device to perform operations further comprising:
receiving an audio input associated with ambient noise sampling at the location;
associating the location or a location category with the received audio input; and
transmitting the audio input and associated location or location category information to a remote computing device for generating the voice recognition model for the associated location or location category based on the received audio input.

24. The non-transitory processor-readable medium of claim 17, wherein the stored processor-executable instructions are configured to cause a processor of a computing device to perform operations further comprising:
compiling an audio profile from an audio input associated with ambient noise at the location;
associating the location or a location category with the compiled audio profile; and
transmitting the audio profile associated with the location or location category to a remote computing device for generating the voice recognition model for the location or location category based on the compiled audio profile.

25. A method performed by a computing device for generating a speech recognition model, comprising:
receiving, from user equipment remote from the computing device, an audio input and location information associated with a location where the audio input was recorded;
using the received audio input to generate a voice recognition model associated with the location for use in voice and/or speech recognition; and
providing the generated voice recognition model associated with the location to the user equipment.

26. The method of claim 25, wherein:
receiving the audio input and location information further comprises receiving a plurality of audio inputs, each having location information associated with different locations; and
using the received audio input to generate a voice recognition model associated with the location further comprises using the received plurality of audio inputs to generate voice recognition models, wherein each of the generated voice recognition models is configured to be used. at a respective one of the different locations.

27. The method of claim 25, further comprising:
determining a location category based on the location information received from the user equipment; and
associating the generated voice recognition model with the determined location category.

28. A computing device, comprising:
a processor configured with processor-executable instructions to:
receive, from user equipment remote from the computing device, an audio input and location information associated with a location where the audio input was recorded;
use the received audio input to generate a voice recognition model associated with the location for use in voice and/or speech recognition; and provide the generated voice recognition model associated with the location to the user equipment.

29. The computing device of claim 28, wherein the processor is further configured with processor-executable instructions to:
receive the audio input and location information from a plurality of audio inputs, each having location information associated with different locations; and
use the received audio input to generate voice recognition models associated with the location using the received plurality of audio inputs, wherein each of the generated voice recognition models is configured to be used at a respective one of the different locations.

30. The computing device of claim 28, wherein the processor is further configured with processor-executable instructions to:
determine a location category based on the location information received from the user equipment; and
associate the generated voice recognition model with the determined location category.
